(19) United States
(12) Patent Application Publication
(10) Pub. No.: US 2025/0147753 A1
(43) Pub. Date: May 8, 2025

(54) INCREMENTAL MACHINE LEARNING MODEL DEPLOYMENT

(71) Applicant: Nokia Technologies Oy, Espoo (FI)

(72) Inventors: Serhan Gul, Berlin (DE); Homayun Afrabandpey, Espoo (FI); Saba Ahsan, Espoo (FI); Hamed Rezazadegan Tavakoli, Espoo (FI); Igor Danilo Diego Curcio, Gravina di Catania (IT); Gazi Karam Illahi, Helsinki (FI)

(21) Appl. No.: 18/939,097

(22) Filed: Nov. 6, 2024

Related U.S. Application Data
(60) Provisional application No. 63/547,412, filed on Nov. 6, 2023.

(51) Int. Cl. G06F 8/658; G06N 5/04

(52) U.S. Cl. CPC G06F 8/658; G06N 5/04

(57) ABSTRACT

In accordance with example embodiments of the invention there is at least a method and apparatus to perform executing a machine learning inference loop of a currently deployed or stored at least one machine learning model, wherein the currently deployed or stored at least one machine learning model is identified based on a manifest file received from a communication network; based on determined factors, requesting from the communication network a model update to trigger the model update for use with the currently deployed or stored at least one machine learning model; based on the request, receiving information from the communication network comprising the model update; and based on the information, performing a model update to update the currently deployed or stored at least one machine learning model. Further, receiving, based on determined factors, from a user equipment a communication to trigger a machine learning model update for use with a currently deployed or stored at least one machine learning model at the user equipment; based on the communication, determining information comprising the model update; based on the determining, sending towards the client the information comprising the model update for a model update to update the currently deployed or stored at least one machine learning model.

### TECHNICAL FIELD

The teachings in accordance with the exemplary embodiments of this invention relate generally to new machine learning and artificial intelligence means and methods for deployment of (pre-trained) ML models and, more specifically, relate to a new machine learning and artificial intelligence means and methods for deployment of (pre-trained) ML models in an incremental fashion from service provider infrastructure to a device over a network.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
AI: Artificial Intelligence
DNN: Deep Neural Network
ML: Machine Learning
NN: Neural Network
QoE Quality of Experience

Some standards at the time of this application are based on artificial intelligence (AI) and machine learning (ML) services that are becoming popular even as consumer applications. 3GPP 5G and future networks are envisioned to enable such services with network-based support for service deployment and network-based inference.

Example embodiments of this invention proposes improved operations for at least these services.

### SUMMARY

This section contains examples of possible implementations and is not meant to be limiting.

In an example aspect of the invention, there is an apparatus, such as a user equipment side apparatus, comprising: at least one processor; and at least one non-transitory memory storing instructions, that when executed by the at least one processor, cause the apparatus at least to: execute a machine learning inference loop of a currently deployed or stored at least one machine learning model wherein the currently deployed or stored at least one machine learning model is identified based on a manifest file received from a communication network; based on determined factors, request from the communication network a model update to trigger the model update for use with the currently deployed or stored at least one machine learning model; based on the request, receive information from the communication network comprising the model update; and based on the information, perform a model update to update the currently deployed or stored at least one machine learning model.

In still another example aspect of the invention, there is a method, comprising: executing a machine learning inference loop of a currently deployed or stored at least one machine learning model, wherein the currently deployed or stored at least one machine learning model is identified based on a manifest file received from a communication network; based on determined factors, requesting from the communication network a model update to trigger the model update for use with the currently deployed or stored at least one machine learning model; based on the request, receiving information from the communication network comprising the model update; and based on the information, performing a model update to update the currently deployed or stored at least one machine learning model.

A further example embodiment is an apparatus and a method comprising the apparatus and the method of the previous paragraphs, wherein performing the model update comprises: based on the information from the communication network, establishing a bit incremental model delivery for a split inference session; and based on the bit incremental model delivery, identify during each of more than one occasion an inference output result from the artificial intelligence inference engine, wherein based on an inference output result at each occasion of the more than one occasion, the model update comprises a model subset bit precision update of the currently deployed or stored at least one machine learning model, wherein the currently deployed or stored at least one machine learning model is based on identifying a machine learning model to be downloaded; and requesting an the identified machine learning model from a server of the communication network, wherein the model update is received with an artificial intelligence model access function of the apparatus, wherein a model run by an inference engine is updated to a higher precision using the model update, wherein the model update is performed on the deployed or stored at least one machine learning model without affecting inference operations being executed by the inference engine, wherein there is performing a hot swap between the currently deployed at least one machine learning model and an updated model based on the model update, wherein the model update is based on one or more of: a model manifest file, information about client resources, network conditions, or machine learning application requirements, wherein there is receiving an identified model manifest file from the communication network; and based on at least part of the manifest file, identifying a lower precision version of a model or a model subset to be downloaded for use by the artificial intelligence inference engine, wherein the lower precision version of a model or a model subset comprises a representation wherein some or all weights are represented using a bit precision representation lower than that of a corresponding higher precision model or model subset, wherein the lower precision version of a model or a model subset comprises a representation wherein some or all weights are quantized versions of the corresponding weights in a higher precision model or model subset, wherein the lower precision version of a model or a model subset comprises a representation wherein some parts of the computational graph in a higher precision model are pruned, for example, by setting the value a node and its subsequent child nodes to zero, wherein the identified model manifest file is based on one or more of: client resources, network conditions; or machine learning application requirements, wherein the triggering the model update is at a particular time period, and wherein the particular time period is one of: immediately after receiving the at least one machine learning model, or triggering the model update after a period of time, and/or wherein the determined factors comprise at least one of: a model update delivery time, achievable machine learning model accuracy, prospective accuracy improvement achievable with a model update, or a change in accuracy requirements of the client application.

A non-transitory computer-readable medium storing program code, the program code executed by at least one processor to perform at least the method as described in the paragraphs above.

In yet another example aspect of the invention, there is an apparatus comprising: means for executing a machine learning inference loop of a currently deployed or stored at least one machine learning model, wherein the currently deployed or stored at least one machine learning model is identified based on a manifest file received from a communication network; means, based on determined factors, for requesting from the communication network a model update to trigger the model update for use with the currently deployed or stored at least one machine learning model; means, based on the request, for receiving information from the communication network comprising the model update; and means, based on the information, for performing a model update to update the currently deployed or stored at least one machine learning model.

In accordance with the example embodiments as described in the paragraph above, at least the means for executing, requesting, receiving, and performing comprises a network interface, and computer program code stored on a computer-readable medium and executed by at least one processor.

In another example aspect of the invention, there is an apparatus, such as a network side apparatus, comprising: at least one processor; and at least one non-transitory memory storing instructions, that when executed by the at least one processor, cause the apparatus at least to: receive, based on determined factors, from a user equipment a communication to trigger a machine learning model update for use with a currently deployed or stored at least one machine learning model at the user equipment; based on the communication, determine information comprising the model update; based on the determining, send towards the client the information comprising the model update for a model update to update the currently deployed or stored at least one machine learning model.

In still another example aspect of the invention, there is a method, comprising: receiving, based on determined factors, from a user equipment a communication to trigger a machine learning model update for use with a currently deployed or stored at least one machine learning model at the user equipment; based on the communication, determining information comprising the model update; based on the determining, sending towards the client the information comprising the model update for a model update to update the currently deployed or stored at least one machine learning model.

A further example embodiment is an apparatus and a method comprising the apparatus and the method of the previous paragraphs, wherein there is based on the information, establishing a bit incremental model delivery for a split inference session; and based on the bit incremental model delivery, identifying during each of more than one occasion an inference output result from the artificial intelligence inference engine, wherein based on an inference output result at each occasion of the more than one occasion, the model update comprises a model subset bit precision update of the currently deployed or stored at least one machine learning model, wherein the currently deployed or stored at least one machine learning model is based on receiving from the user equipment a request an the identified machine learning model to be downloaded by the user equipment, wherein the currently deployed or stored at least one machine learning model is based on receiving from the user equipment a request for an identified machine learning model, wherein the machine learning model update is sent with a network application, wherein the machine learning model update is for updating the at least one of the currently deployed or stored at least one machine learning model to a higher precision model, wherein the machine learning model update is for use on the stored at least one machine learning model without affecting inference operations being executed by the client, wherein the precision update comprises a hot swap between the currently deployed at least one machine learning model and an updated model based on the precision update, wherein the model update is based on one or more of: a model manifest file, information about client resources, network conditions, or machine learning application requirements, wherein there is sending an identified model manifest file from the communication network, wherein based on at least part of the manifest file, a lower precision version of a model or a model subset can be identified to be downloaded for use by the client, wherein the lower precision version of a model or a model subset comprises a representation wherein some or all weights are represented using a bit precision representation lower than that of a corresponding higher precision model or model subset, wherein the lower precision version of a model or a model subset comprises a representation wherein some or all weights are quantized versions of the corresponding weights in a higher precision model or model subset, wherein the lower precision version of a model or a model subset comprises a representation wherein some parts of the computational graph in a higher precision model are pruned, for example, by setting the value a node and its subsequent child nodes to zero, wherein the identified model manifest file is based on one or more of: client resources, network conditions; or machine learning application requirements, wherein the triggering the model update is at a particular time period, and wherein the particular time period is one of: immediately after receiving the at least one machine learning model, or triggering the model update after a period of time, and/or wherein the determined factors comprise at least one of: a model update delivery time, achievable machine learning model accuracy, prospective accuracy improvement achievable with a model update, or a change in accuracy requirements of the client application.

A non-transitory computer-readable medium storing program code, the program code executed by at least one processor to perform at least the method as described in the paragraphs above.

In yet another example aspect of the invention, there is an apparatus comprising: means for receiving, based on determined factors, from a user equipment a communication to trigger a machine learning model update for use with a currently deployed or stored at least one machine learning model at the user equipment; means, based on the communication, for determining information comprising the model update; means, based on the determining, for sending towards the client the information comprising the model update for a model update to update the currently deployed or stored at least one machine learning model.

In accordance with the example embodiments as described in the paragraph above, at least the means for receiving, determining, and sending comprises a network interface, and computer program code stored on a computer-readable medium and executed by at least one processor.

A communication system comprising the network side apparatus and the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows a scenario of incremental model deployment;

FIG. 2A and FIG. 2B each show some meta-data used to help identify models and model subsets among other aspects for split AI/ML operations;

FIG. 3A and FIG. 3B each show meta-data parameters and corresponding description parameters;

FIG. 4 shows an exemplary incremental model deployment scenario where a server and model repository may be collocated;

FIG. 5 shows an exemplary call flow and procedure for incremental model deployment in communication networks;

FIG. 6 shows a network data source signalling call flow and procedure in accordance with example embodiments of the invention, for incremental model deployment in communication networks;

FIG. 7 shows a UE data source signalling call flow and procedure in accordance with example embodiments of the invention, for incremental model deployment in communication networks;

FIG. 8 shows a high level block diagram of various devices used in carrying out various aspects of the invention; and

FIG. 9A and FIG. 9B each show a method in accordance with example embodiments of the invention which may be performed by an apparatus.

### DETAILED DESCRIPTION

In example embodiments of this invention there is proposed at least a method and apparatus for new machine learning and artificial intelligence means and methods for deployment of (pre-trained) ML models in an incremental fashion from service provider infrastructure to a device over a network.

As similarly stated above, AI and ML services are becoming popular even as consumer applications. Communication networks like 3GPP or 5G and future networks are envisioned to enable such services with network-based support for service deployment and network-based inference.

ML models, for example, neural networks may be viewed as a computing graph, conceptually comprising layers which comprise nodes and their corresponding numerical weights. A weight may be represented as a floating-point number. The precision of a floating-point number may depend upon the number of bits used to represent the number.

ML models, for example, neural networks may comprise a large number of such layers and nodes, and consequently may need a large number of bits to be represented, resulting in a large size. Therefore, an ML model may take significant time to be deployed from an application service provider to the network and on to the UE on which at least some of the inference may take place. The significant size and the corresponding deployment time may result in undesired latency before the UE can start performing inference. This latency, which may be referred to as inference startup latency, can have detrimental effects on a user's Quality of Experience (QoE).

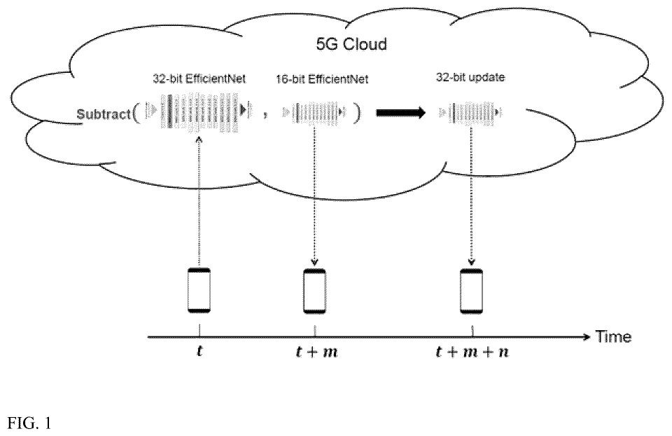

Standards at the time of this application describe a scenario of incremental model deployment. FIG. 1 shows such a scenario of incremental model deployment.

The scenario considered is one wherein the UE does inference on a pre-trained model which it acquires from a server in the network. It is assumed that the server has access to different versions of the same model, with each model having different bit precisions. Further, the server may have access to model updates. Alternatively or in addition the server may have the ability to create model updates. The model update can be indicated as and/or be based on factors such as any related operations. Such operations are not limited but may include a difference between high precision and low precision models or other measurement. By adding the model update to the lower bit precision model, the corresponding higher bit precision model could be acquired. The deployment scenario is described below:
The server receives a request for a model of a low bit precision at time t
The low bit-precision model may already be available at the server. In some embodiments, if the low bit-precision model is not available, Server creates a low bit-precision model M_{L} and a model update Mᵤ from the available high bit-precision model M_{H}. The server may calculate a model update as the difference between the high bit-precision and low bit-precision version of the model;
The server sends M_{L} (and hence smaller size) model to the UE, which arrives at the UE at time t+m;
The UE can already start inference after receiving M_{L} completely, at time t+m potentially with lower accuracy;
The server sends the update Mᵤ to the UE, which arrives at the UE at time t+m+n;
The UE can recreate a high bit-precision model M_{H} by combining M_{L} and Mᵤ, e.g. by adding the corresponding weight parameters in M_{H} and Mᵤ.

In addition, standards at the time of this application include example procedures for Split inference between a UE and a 3GPP network, while providing a high level procedure of Split AI/ML operation in the context of the envisioned architecture.

Procedures for split inferencing are discussed wherein at least a part of ML inference operations are executed by a UE and another part of the ML inference operations are executed by an entity in the 3GPP network. Two scenarios of input data origin: UE and Network are discussed. The corresponding input data flow, intermediate data flow and inference data consumption etc., are also considered.

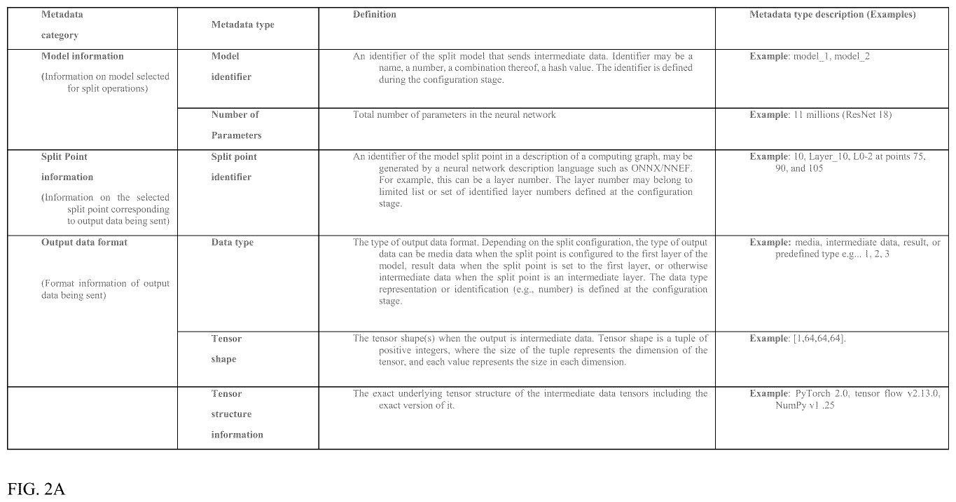

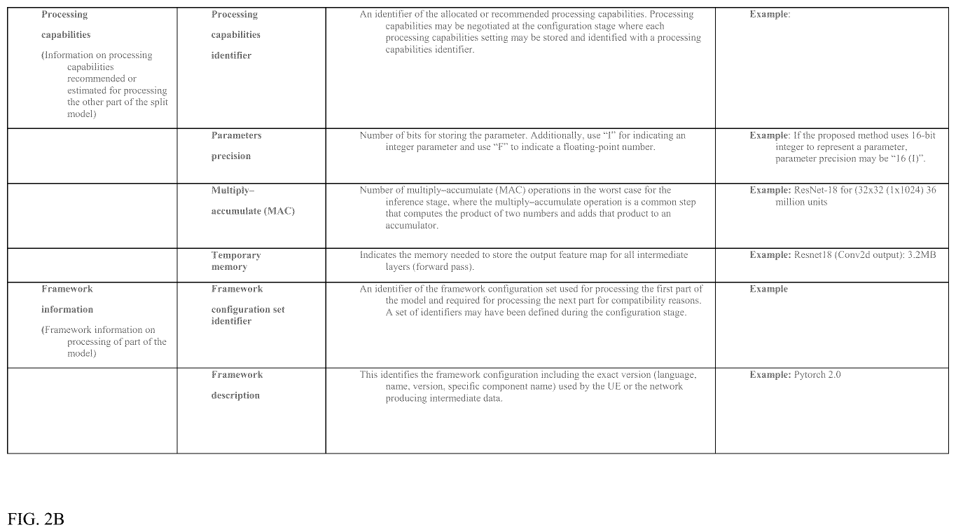

FIG. 2A and FIG. 2B each show some meta-data used to help identify models and model subsets among other aspects for split AI/ML operations.

When a large ML model, for example, a DNN model is transferred to a UE from a network entity, Inference startup latency at the UE may be high. Below is an example scenario of this problem:

In this scenario, a user starts an app on their UE to perform real-time object detection in the video stream captured by a UE camera, for example in an Augmented Reality (AR) use case. The app may use a pretrained ML model for the task. An example of such a model may be VGG16[1]. A pretrained VGG16 model can be up to 528 MB in size, which can take substantial time to be downloaded from a service provider model repository, even if the repository is hosted in the 5G network. For example, on a link with average capacity of 100 Mbps with even a low access latency of 10 ms, it may take up to a minute for the model to be downloaded. One minute of startup latency can be quite detrimental in a latency sensitive usage scenario such as AR in general and in latency critical usage scenarios such as AR for driving, machine operation or emergency care.

Incremental model delivery can improve inference startup latency. While incremental models are considered in state of the art, there is no application-level signaling mechanisms to enable deployment of such models. These include syntax and semantic information to identify available models, model subsets, corresponding precisions, and incremental updates. Methods and means by which to choose a particular precision model are also not defined. Further, signaling aspects to support incremental model deployment, deployment of updates etc., have not been developed.

Example embodiments of the invention disclose means and methods for deployment of (pre-trained) ML models in an incremental fashion from service provider infrastructure to a device over a network.

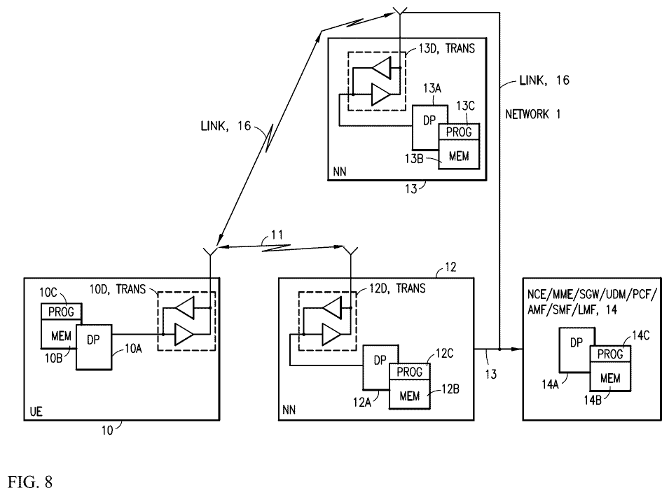

Before describing the example embodiment of the invention as disclosed herein in detail, reference is made to FIG. 8 for illustrating a simplified block diagram of various electronic devices that are suitable for use in practicing the example embodiments of this invention.

FIG. 8 shows a block diagram of one possible and non-limiting exemplary system in which the example embodiment of the invention may be practiced. In FIG. 8, a user equipment (UE) 10 is in wireless communication with a wireless network 1 or network, 1 as in FIG. 8. The wireless network 1 or network 1 as in FIG. 8 can comprise a communication network such as a mobile network e.g., the mobile network 1 or first mobile network as disclosed herein. Any reference herein to a wireless network 1 as in FIG. 8 can be seen as a reference to any wireless network as disclosed herein. Further, the wireless network 1 as in FIG. 8 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12 and NN 13, respectively. The one or more memories MEM 10B include computer program code PROG 10C. The UE 10 communicates with NN 12 and/or NN 13 via a wireless link 11 or 16.

The NN 12 (NR/5G Node B, an evolved NB, or LTE device) is a network node such as a master or secondary node base station (e.g., for NR or LTE long term evolution) that communicates with devices such as NN 13 and UE 10 of FIG. 8. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiment of the invention these TRANS 12D can include X2 and/or Xn interfaces for use to perform the example embodiments. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 16. Further, the link 11, link 16 and/or any other link may be wired or wireless or both and may implement, e.g., an X2 or Xn interface. Further the link 11 and/or link 16 may be through other network devices such as, but not limited to an NCE/MME/SGW/UDM/PCF/AMF/SMF/LMF 14 device as in FIG. 8. The NN 12 may perform functionalities of an MME (Mobility Management Entity) or SGW (Serving Gateway), such as a User Plane Functionality, and/or an Access Management functionality for LTE and similar functionality for 5G.

The NN 13 can be for WiFi or Bluetooth or other wireless device associated with a mobility function device such as an AMF or SMF, further the NN 13 may comprise a NR/5G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiment of the invention these network interfaces of NN 13 can include X2 and/or Xn interfaces for use to perform the example embodiments. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or link 16 or another link. The Link 16 as shown in FIG. 8 can be used for communication with the NN12. These links maybe wired or wireless or both and may implement, e.g., an X2 or Xn interface. Further, as stated above the link 11 and/or link 16 may be through other network devices such as, but not limited to an NCE/MME/SGW device such as the NCE/MME/SGW/UDM/PCF/AMF/SMF/LMF 14 of FIG. 8.

The one or more buses of the device of FIG. 8 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to a RRH.

It is noted that although FIG. 8 shows a network nodes such as NN 12 and NN 13, any of these nodes may can incorporate or be incorporated into an eNodeB or eNB or gNB such as for LTE and NR, and would still be configurable to perform example embodiments.

Also it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF/LMF 14 is configurable to perform operations in accordance with example embodiments in any of an LTE, NR, 5G and/or any standards based communication technologies being performed or discussed at the time of this application. In addition, it is noted that the operations in accordance with example embodiments, as performed by the NN 12 and/or NN 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/W I/F(s)), interconnected through one or more buses coupled with the link 13 and/or link 16. In accordance with the example embodiments these network interfaces can include X2 and/or Xn interfaces for use to perform the example embodiments. The one or more memories MEM 14B include computer program code PROG 14C. The one or more memories MEM14B and the computer program code PROG 14C are configured to, with the one or more processors DP 14A, cause the NCE/MME/SGW/UDM/PCF/AMF/SMF/LMF 14 to perform one or more operations which may be needed to support the operations in accordance with the example embodiments.

It is noted that that the NN 12 and/or NN 13 and/or UE 10 can be configured (e.g. based on standards implementations etc.) to perform functionality of a Location Management Function (LMF). The LMF functionality may be embodied in any of these network devices or other devices associated with these devices. In addition, an LMF such as the LMF of the MME/SGW/UDM/PCF/AMF/SMF/LMF 14 of FIG. 8, as at least described below, can be co-located with UE 10 such as to be separate from the NN 12 and/or NN 13 of FIG. 8 for performing operations in accordance with example embodiment of the invention as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP10, DP12A, DP13A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, NN 13, and other functions as described herein.

In general, various embodiments of any of these devices can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Further, the various embodiments of any of these devices can be used with a UE vehicle, a High Altitude Platform Station, or any other such type node associated with a terrestrial network or any drone type radio or a radio in aircraft or other airborne vehicle or a vessel that travels on water such as a boat.

As similarly stated above, example embodiments of the invention includes means and methods for deployment of (pre-trained) ML models in an incremental fashion from service provider infrastructure to a device over a network.

Conceptually, at least three aspects are disclosed:
1. Metadata to enable identification of a model, available versions of the model (for example different versions which differ in precision), available precision updates for the model, size of the different versions of the model, computational complexity and/or requirements of the different versions of the model, performance information of the versions of the model (e.g. accuracy and inference speed on an appropriate benchmark) and other information which may facilitate a client in the process of identifying and acquiring a model appropriate for its use case.
2. Methods for selection of a model to be used by a client for inference.
3. Signaling for incremental model deployment over communication networks, especially, in 3GPP networks wherein the network may comprise some or all parts of service provider infrastructure.

The startup inference latency can be reduced by deploying an ML model incrementally. Incremental model deployment could be interpreted in at least two ways:

(1) incremental partial delivery of a model, where layers of a model are delivered one by one or in other increments than complete model delivery.
(2) Incremental model deployment comprising delivery of a compressed or smaller in size model to the UE to start the inference potentially with lower bit-width, i.e. the weights of the model are having a lower bit-width representation, wherein the smaller in size or condensed functional model can be updated to a larger in size or uncondensed form by applying one or more model updates.

Example embodiments of the invention can relate to the delivery of smaller in size or condensed model and subsequent delivery of updates. Since the size of the smaller in size or condensed model is smaller, it takes less time to be downloaded to a UE compared to a full uncondensed model. This smaller in size or condensed model can then be updated over time with incremental updates to an uncondensed model.

Smaller in size or condensed models which comprise functional models with smaller sizes which are updatable to an uncondensed version of the model may be created directly by designing and training the model appropriately or obtained from a larger in size or uncondensed transmission size model in a variety of ways, for example, by using fewer bits to represent weights of a larger in size or uncondensed model or by pruning out a subgraph of the a larger in size or uncondensed model or by quantizing the weights with a particular (quantization) factor or a combination of these.

It is noted that the term condensed model as used herein may be illustratively to indicate a smaller sized model functional model, potentially with lower accuracy, obtained from a full size model which has potentially higher accuracy such that the smaller sized model may be updated back to a higher sized model with higher accuracy by means of applying a model update. By size we refer to transmission or storage size: The potential reduction in accuracy as a consequence of reduction in size is partially or fully reversible with the application of model updates.

Pruning is the process of removing weight connections in a network to increase inference speed and decrease model storage size. Neural networks may be over parameterized. Pruning a network may be thought of as removing unused parameters from the over-parameterized network, which may be conceptually equivalent to removing one or more subgraphs from a neural network computational graph.

These smaller in size or condensed models may be incremented to larger in size or uncondensed models by applying one or more updates which in the former case increase the bit precision of the weights and in the latter case add more parts of the pruned-out graph to a lower precision model and/or a higher precision model.

In the below description of the invention, we provide illustrative examples which consider incremental model deployment: In example embodiments of the invention concerning incremental model deployment, we refer to a smaller in size or condensed model as low bit-precision model and to a larger in size or uncondensed model as a high bit precision model, This terminology is illustrative and exemplary and should not be construed as exclusionary to example embodiments of the invention where smaller in size or condensed models and corresponding updates are obtained by other viable means, such as pruning, selective quantization or a combination thereof.

A service provider providing ML based applications to a client may utilize computing and network infrastructure to provide the service. The infrastructure may include a repository containing pre-trained ML models corresponding to the ML applications provided. The repository may contain different versions of the same model, wherein the models may differ in one or more of: precision, complexity, size, training use case (such as training data and training targets/labels/classes), expected input size and format, model format, model file format, (reference) accuracy, storage location etc. In case of incremental model delivery scenarios, additional information like possibility of precision updates, availability of precision updates, post update (reference) accuracy etc.

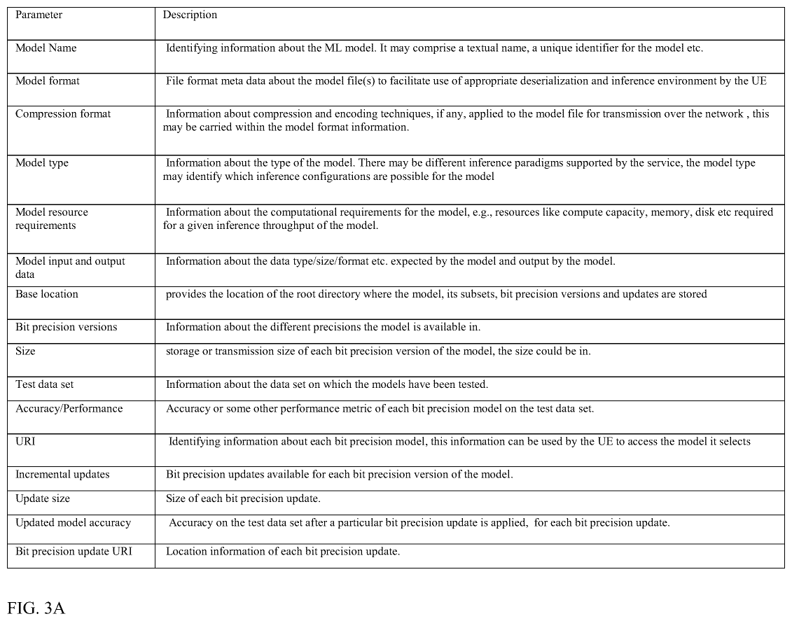

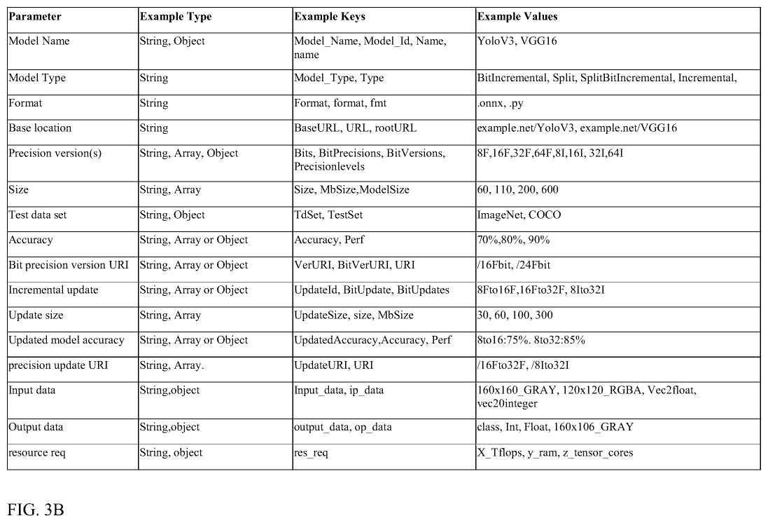

When providing such models to a client, some or all of this information or meta-data, may be required to identify a model which is appropriate for the client, based on client use case and requirements. An exemplary non-exhaustive list of this meta-data for a bit-incremental model deployment scenario is provided as meta-data parameters with a corresponding description of the parameters as shown in FIG. 3A

A list of this model meta-data, hereinafter referred to as model manifest, may be variously represented.

In an example embodiment of the invention, the model manifest may comprise key-value structured data as shown in the table of FIG. 3B. The parameters listed are non-exhaustive and the key labels are exemplary.

In some example embodiments of the invention, the model manifest may comprise information represented in a flat manner, for example, for a bit incremental deployment scenario, such a representation in JSON format may look like: {Model_name=YoloV3; Model-type=bit incremental; BaseURL: example.net/YoloV3: bits=16 bit, 32 bit, 64 bit, ModelSize=60, 110, 200, accuracy=85, 90, 95; URI:/16 bit, /32 bit, /64 bit; BitUpdates: 16to32,32to64,16to64, UpdateSize: 40, 60, 110, BitUpdatedAccuracy=89.5, 94.5,94.7, URI:/16to32, /32to64, /16to64}.

In flat representations, the order of the key-value pairs may indicate the correspondence between different parameters.

In some example embodiments of the invention, the model manifest may comprise information represented in a hierarchical manner, for example, for a bit incremental deployment scenario, such a representation in JSON format may look like:

```
{“Models”:{
  “name”:“YoloV3”, “type”:“BitIncremental”,
“URL”:“example.net/YoloV3”,“NumParams”:“8.8M”,
  “TdSet”:“COCO”,
“TdSet”:{“dataset”:“COCO”,“Classes”:“50”,“split”:“70/30”},
  “BitVersions”:{
  “8F”:{“size”:“60”,“Accuracy”:“70%”,“URI”:“/8Fbit”,″More info”:“e.g.
precision level this model can be updated to”},
  “16F”:{“size”:“110”,“Accuracy”:“82%”,“URI”:“/16Fbit”,“More info”:“e.g.
precision level this model can be updated to”},
    }
  “BitUpdates”:{
  “8Fto16F”:{“size”:“30”,“BitUpdatedAccuracy”:“75%”,“URI”:“/8Fto16F”,
“More info”:“....”},
  “16Fto32F”:{“size”:“60”,“BitUpdatedAccuracy”:“85%”,“URI”:“/16Fto32F”,
“More info“:“.....”},
    }
  }
}
```

In an example embodiment of the invention, a model manifest is shared as a manifest file, e.g. as an HTML, XML or JSON document. In some embodiments, the manifest file is pointed to by a URI/URL and the URI/URL is shared.

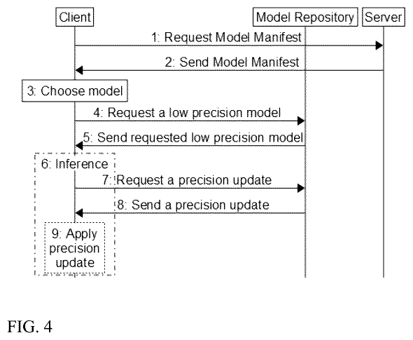

An exemplary incremental model deployment scenario is illustrated in FIG. 4. FIG. 4 shows communication between a client, a server, and a model repository. The server and model repository as in FIG. 4 may be collocated.

As shown in step 1 of FIG. 4 the Client requests from the Server a model manifest. As shown in step 2 of FIG. 4 the Server sends a model manifest. As shown in step 3 of FIG. 4 the Client choses a model. As shown in step 4 of FIG. 4 the Client requests from the Model repository a low precision model. As shown in step 5 of FIG. 4 the Model Repository sends the requested low precision model. As shown in step 6 of FIG. 4 the Client performs an Inference. As shown in step 7 of FIG. 4 the Client sends to the Model repository a request for a precision update. As shown in step 8 of FIG. 4 the Model Repository sends to the Client a precision update. Then as shown in step 9 of FIG. 4 the Client is applying the precision update. Also as shown with the dotted lines around steps 7-9 of FIG. 4 it is shown that the client keeps performing inference while the steps 7-9 are taking place.

In an example embodiment of the invention, a client receives a model manifest file from a server and based on some or all the information in the manifest file, identifies a low precision model to be downloaded and requests the identified model from a server, receives the requested low precision model, and executes it for inference.

In an embodiment of the above embodiments, the client further requests a precision update, receives the precision update and applies it on the previously received low precision model.

In an embodiment of the above embodiment, the identification of a model is further based on one or more of: Client resources e.g. computational resources, available memory, remaining battery, running software version (e.g., OS), inference runtime; Network conditions e.g. network latency, available bandwidth, number of devices in the vicinity and number of requests; and ML application requirements e.g. desired inference rate, desired minimum accuracy, desired maximum startup latency, input data, output data, etc.

In an example embodiments of the invention, a split inference as herein can refer to a ML inference paradigm where parts of an inference operation are executed in by different entities, wherein an output from one partial inference option may be an input for another partial split operation. In such scenarios, an ML model may be split into multiple parts which are deployed in different entities. Such portions of an ML model, herein after referred to as model subsets, may also be deployed in an incremental fashion.

In an example embodiment of the invention, the model manifest further comprises information identifying: split options available for a model (i.e. different model subset configurations), precision versions of model subsets, size of different precision versions of model subsets, complexity of different precision versions of model subsets, accuracy for each precision version of the model subset, precision updates available, their size and accuracy after update, input and output for each precision version model. It is noted that a low precision version of a model subset precision refers to weights with lower bit precision, and a model subset can be referred to as a pruned model.

It is noted that if the options are 8 and 16-bit, then 16-bit is high-precision, or if the options are 16 and 32-bit, then 16-bit is low-precision.

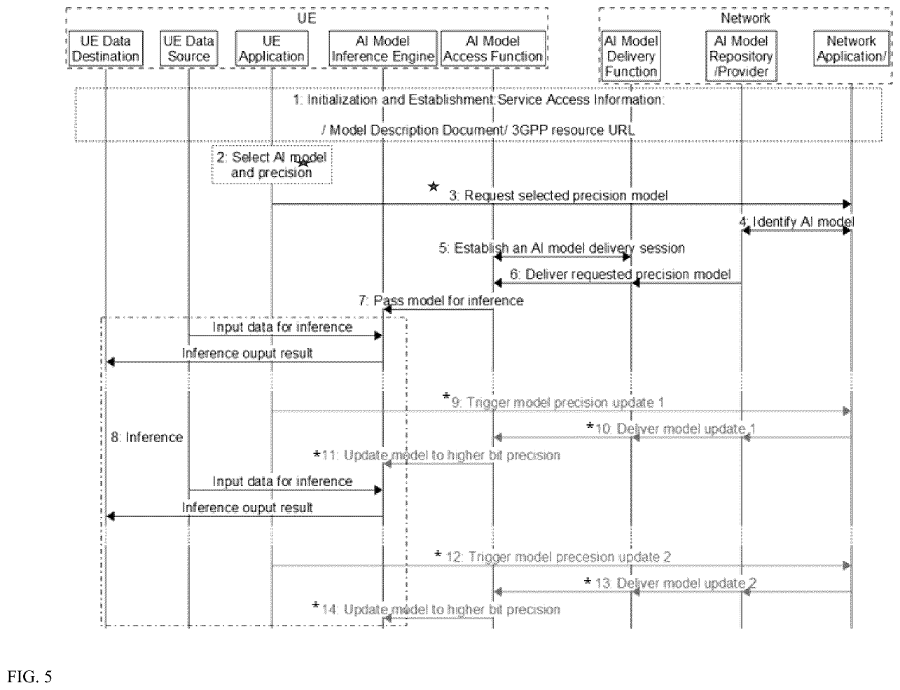

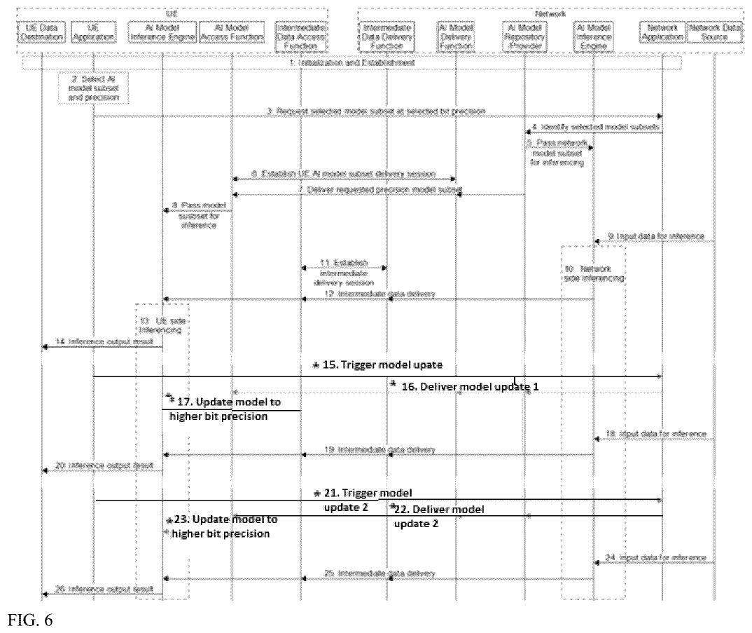

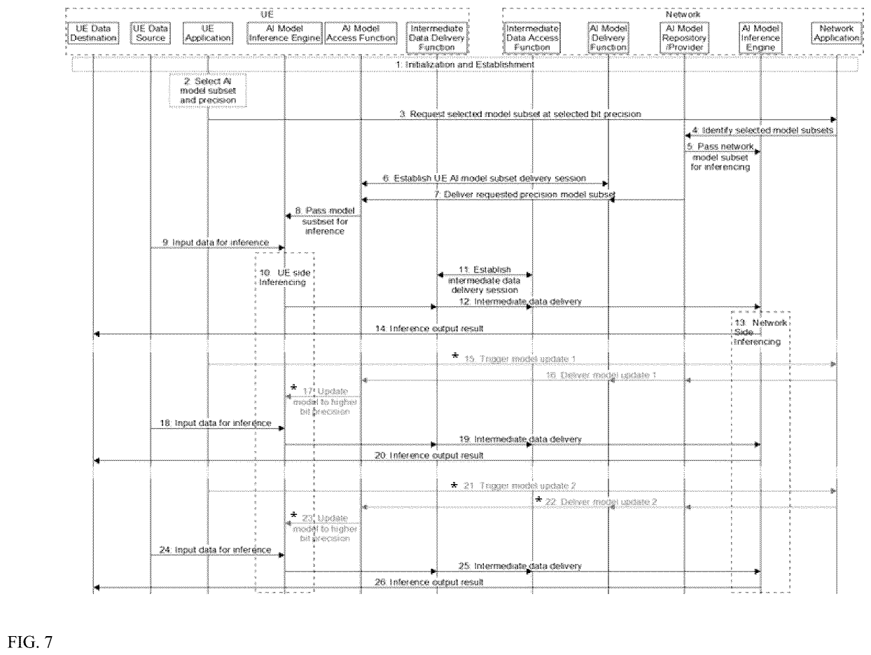

FIG. 5, FIG. 6, and FIG. 7 each show new and novel operations in accordance with example embodiments of the invention. It is noted that these new and novel operations are identified in each FIG. with an asterisk *.

IN FIG. 5 there is provided an exemplary call flow and procedure for incremental model deployment in 5G networks.

Steps of FIG. 5 as follows:
1. The UE Application and Network Application communicate to establish a bit incremental model delivery session. The UE Application may receive Service Access information to learn about available services and configurations. This information may comprise a model manifest as discussed in various embodiments above;
2. An AI model and bit precision is selected by the UE Application, based on, e.g., UE resources, network conditions, AI application and model information shared by the network application;
3. The UE application requests the selected precision model from the Network Application;
4. The Network Application identifies the selected AI model in the AI model Repository/Provider;
5. The AI Model Access Function establishes an AI model delivery session with the AI Model Delivery Function;
6. The AI Model Access Function receives the AI model of the precision requested by the UE;
7. The AI Model Access Function passes the AI/ML model to the AI model Inference Engine in the UE;
8. Inference loop: The Data Source passes data to the AI model Inference Engine, AI Model Inference Engine performs AI inferencing, and AI Model Inference Engine passes the inference output result to the UE Data Destination for consumption;
9. In this novel step 9 of FIG. 5 identified as novel by an asterisk the UE application triggers a model update or a model precision update (parallel to the inferencing loop of step 8). The update is a precision update of the model currently at the UE (steps 6-7) rather than a new model.

It is noted that a UE application may trigger a model update or a model precision update immediately after receiving the AI/ML Model or it may trigger the model update after a period of time. The UE application may trigger the model update based on a variety of factors including, but not limited to, model update delivery time, AI/ML model accuracy achieved at the UE, prospective accuracy improvement achievable with a model update, change in accuracy requirements of the UE application, etc.;
10. In this novel step 10 of FIG. 5 identified as novel by an asterisk, the model update is delivered to the AI model access function;
11. In this novel step 11 of FIG. 5 identified as novel by an asterisk the model in the inference engine is updated to a higher precision using the model update from 10;
12. In this novel step 12 of FIG. 5 identified as novel by an asterisk the UE send to the network a trigger model update or a model precision update 2;
13. In this novel step 13 of FIG. 5 identified as novel by an asterisk the network responds to the UE with a deliver model update 2;
14. In this novel step 14 of FIG. 5 identified as novel by an asterisk the UE updates with the update model to a higher bit precision.

It is noted that steps 9-11 of FIG. 5 may be repeated as steps 12-13 depending upon number of precision levels, corresponding model updates.

Although not indicated in the call flow diagram, the UE application may participate in applying a model update to a model currently at the UE.

In one example embodiment of the invention, the UE application may have access to a stored copy of the model currently at the UE, and apply the model update to this stored copy of the model without affecting the inference operations being executed by the UE inference engine.

In another example embodiment of the invention, the UE application may perform a hot swap between the current model being executed in the inference engine and an updated model

FIG. 6 provides exemplary call flows and procedures for incremental model deployment in 5G networks in split-inference scenarios.

Steps of FIG. 6 as follows:
1. The UE Application and Network Application communicate to establish a bit incremental model delivery for split inference session. The UE Application may receive Service Access Information to learn about available services and configurations. This information may comprise a model manifest as discussed in various embodiments above;
2. An AI model subset and bit precision is selected by the UE Application, based on, e.g., split ratio it desires/supports, model size and currently available network capacity;
3. The UE Application requests a selected model subset and selected bit precision from the Network Application with the sub-setting/split ratio and bit-precision computed in Step 2;

Note: Sub-setting operation may refer to selecting a sub-set of layers from the set of layers comprising a model for split inference. The subset of layers selected by a UE may be referred to as model subset in the signalling diagrams. Sub-setting ratio may therefore also be referred to as split-ratio, split point etc.;
4. The Network Application identifies the selected AI model and its subsets in the AI model Repository/Provider;
5. The AI Model Repository passes one model subset, the network model subset, to the AI Inference Engine for inference;
6. The AI Model Access Function establishes an AI model subset delivery session with the AI Model Delivery Function;
7. The AI Model Access Function receives the AI model subset of the precision requested by the UE;
8. The AI Model Access Function passes the AI/ML model subset to the AI model Inference Engine in the UE;
9. The Network Data Source passes data to the Network AI Model Inference Engine;
10. The Network AI Model Inference Engine performs AI inferencing to produce intermediate inference data;
11. The UE Intermediate Data Access Function and the Network Intermediate Data Delivery Function establish an intermediate data delivery session;
12. The intermediate data from the Network Inference engine is passed to the UE Inference Engine via the Network Intermediate Data Delivery Function and UE Intermediate Data Access Function.
13. The UE Inference Engine performs inference on the intermediate data;
14. The inference output is passed to the UE Data Destination for consumption; Steps 9,10, 12,13 and 14 continue operating in a loop;
15. In this novel step 15 of FIG. 6 identified as novel by an asterisk, the UE application triggers a model subset bit precision update (parallel to the inferencing loop of steps 9,10,12 and 13). The update is a bit precision update of the model currently deployed at the UE AI Inference Engine;
16. In this novel step 16 of FIG. 6 identified as novel by an asterisk, the model update is delivered to the AI model access function;
17. In this novel step 17 of FIG. 6 identified as novel by an asterisk, the model in the UE Inference Engine is updated to a higher precision using the model update from 16.

It is noted that in step 15 of FIG. 6 for example a UE application may trigger a model update or a model precision update immediately after receiving the AI/ML Model or it may trigger the model update after a period of time. The UE application may trigger the model update based on a variety of factors including, but not limited to, model update delivery time, AI/ML model accuracy achieved at the UE, prospective accuracy improvement achievable with a model update, change in accuracy requirements of the UE application, etc.

Further, this update such as in step 17 of FIG. 6 could be generalized to an update of the model subset too so that the update is either a bit precision update of the model layers currently deployed at the UE and/or it also changes the number of model layers deployed at the UE. Might need corresponding signaling in the network side of the operation as well.);

Although not indicated in the call flow diagram, the UE application may participate in applying a model update to a model currently at the UE.

In one example embodiment, the UE application may have access to a stored copy of the model currently at the UE, and apply the model update to this stored copy of the model without affecting the inference operations being executed by the UE inference engine.

In an example embodiment of the invention, the UE application may perform a hot swap between the current model being executed in the inference engine and an updated model.

Steps 15-17 may be repeated as 21-23 depending upon number of precision levels and corresponding model updates.

Steps 21-23 of FIG. 6 include:
21. In this novel step 21 of FIG. 6 identified as novel by an asterisk the UE send to the network a trigger model update 2;
22. In this novel step 22 of FIG. 6 identified as novel by an asterisk the network responds to the UE with a deliver model update 2;
23. In this novel step 23 of FIG. 6 identified as novel by an asterisk the UE updates with the update model to a higher bit precision.

It is noted that the inference loop (9,10,12,13 and 14) continues while and after the model in UE Inference Engine is update and continues after the update as (18,10,19,20) and (24,10,25,26).

FIG. 7 shows further features in accordance with example embodiments of the invention.

Steps of FIG. 7 as follows:
1. The UE Application and Network Application communicate to establish a bit incremental model delivery for split inference session. The UE Application may receive Service Access Information to learn about available services and configurations, including available models, split ratios, bit precisions and possible updates. This information may be in a 3GPP URI of/or model manifest file(s). The model manifest file contains size, complexity information etc. of the different versions;
2. An AI model subset and bit precision is selected by the UE Application, based on, e.g., split ratio it desires/supports, model size and currently available network capacity;
3. The UE Application requests a selected model subset and selected bit precision from the Network Application with the sub-setting/split-ratio and bit-precision computed in Step 2;
4. The Network Application identifies the selected AI model and its subsets in the AI model Repository/Provider;
5. The AI Model Repository passes one model subset, the network model subset, to the Network AI Inference Engine for inference;
6. The AI Model Access Function establishes an AI model subset delivery session with the AI Model Delivery Function;
7. The AI Model Access Function receives the AI model subset of the precision requested by the UE;
8. The AI Model Access Function passes the AI/ML model subset to the AI model Inference Engine in the UE;
9. The UE Data Source passes data to the UE AI Model Inference Engine;
10. The UE AI Model Inference Engine performs AI inferencing to produce intermediate inference data;
11. The UE Intermediate Data Delivery Function and the Network Intermediate Data Access Function establish an intermediate data delivery session;
12. The intermediate data from the UE Inference Engine is passed to the Network Inference Engine via the UE Intermediate Data Delivery Function and Network Intermediate Data Access Function;
13. The Network Inference Engine performs inference on the intermediate data;
14. The inference output is passed to the UE Data Destination for consumption;
Steps 9,10, 12 and 13, 14 continue operating in a loop;
15. In this novel step 21 of FIG. 7 identified as novel by an asterisk, the UE application triggers a model subset bit precision update (parallel to the inferencing loop of steps 9,10,12,13,14). The update is a bit precision update of the model currently deployed at the UE AI Inference Engine;
16. In this novel step 16 of FIG. 7 identified as novel by an asterisk, the model update is delivered to the AI model access function;
17. In this novel step 17 of FIG. 7 identified as novel by an asterisk, the model in the UE Inference Engine is updated to a higher precision using the model update from step 16.

Although not indicated in the call flow diagram, the UE application may participate in applying a model update to a model currently at the UE.

Further, it is noted that in a step such as step 15 of FIG. 7 the UE application may trigger a model update or a model precision update immediately after receiving the AI/ML Model or it may trigger the model update after a period of time. The UE application may trigger the model update based on a variety of factors including, but not limited to, model update delivery time, AI/ML model accuracy achieved at the UE, prospective accuracy improvement achievable with a model update, change in accuracy requirements of the UE application, etc.

Further, this update such as in step 17 of FIG. 7 could be generalized to an update of the model subset too so that the update is either a bit precision update of the model layers currently deployed at the UE and/or it also changes the number of model layers deployed at the UE. Might need corresponding signaling in the network side of the operation as well.

In one example embodiment, the UE application may have access to a stored copy of the model currently at the UE, and apply the model update to this stored copy of the model without affecting the inference operations being executed by the UE inference engine.

In an example embodiment of the invention, the UE application may perform a hot swap between the current model being executed in the inference engine and an updated model.

Steps 15-17 may be repeated as 21-23 depending upon number of precision levels and corresponding model updates.

Steps 21-23 of FIG. 7 include:
21. In this novel step 21 of FIG. 7 identified as novel by an asterisk the UE send to the network a trigger model update 2;
22. In this novel step 22 of FIG. 7 identified as novel by an asterisk the network responds to the UE with a deliver model update 2;
23. In this novel step 23 of FIG. 7 identified as novel by an asterisk the UE updates with the update model to a higher bit precision.

It is noted that any reference or text referring to a step or operation in any figures, including FIG. 5, FIG. 6, or FIG. 7, as being novel, such as identified by an asterisk, does not imply or indicate in any manner that any other steps as shown in FIG. 5, FIG. 6, or FIG. 7 or any Figure steps are not novel or made novel by operations in accordance with example embodiments of the invention. The use of the term novel or any of its indicators is not limiting to the embodiments of the invention as disclosed herein.

The inference loop (9,10,12,13 and 14) continues while and after the model in UE Inference Engine is updated and continues after the update(s) as (18,10,19,13,20) and (24,10,25,13,26).

In an embodiment, a lower precision version of a model or a model subset comprises a representation wherein some or all weights are represented using a bit precision representation lower than that of a corresponding higher precision model or model subset.

In an embodiment, a lower precision version of a model or a model subset comprises a representation wherein some or all weights are quantized versions of the corresponding weights in a higher precision model or model subset.

In an embodiment, a lower precision version of a model or a model subset comprises a representation wherein some parts of the computational graph in a higher precision model are pruned, for example, by setting the value a node and its subsequent child nodes to zero.

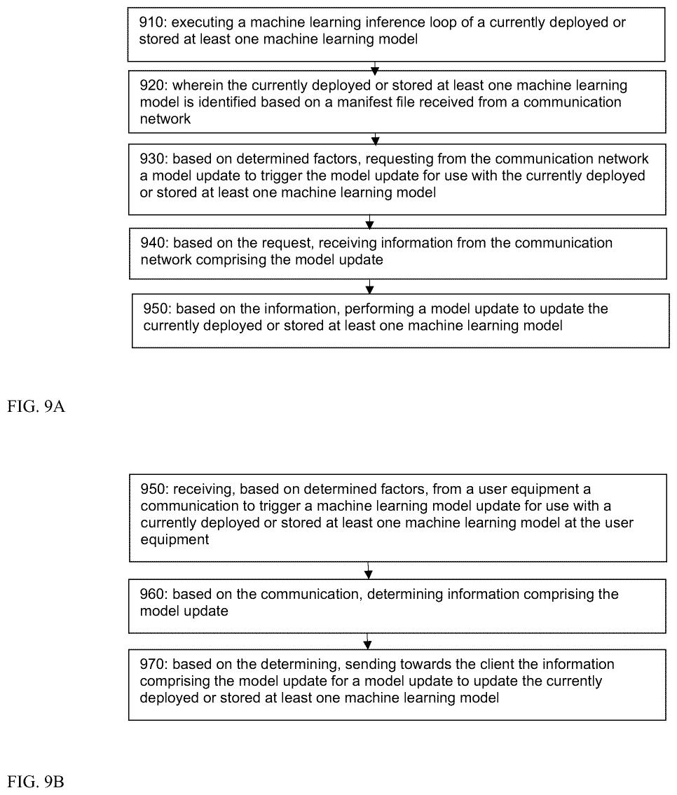

FIG. 9A and FIG. 9B each show a method in accordance with example embodiments of the invention which may be performed by an apparatus.

FIG. 9A shows a method in accordance with example embodiments of the invention which may be performed by an apparatus.

FIG. 9A illustrates operations which may be performed by a device such as, but not limited to, a device such as a user equipment device (e.g., the NN 12 and/or NN 13 as in FIG. 8). As shown in block 910 of FIG. 9A there is executing a machine learning inference loop of a currently deployed or stored at least one machine learning model. As shown in block 920 of FIG. 9A wherein the currently deployed or stored at least one machine learning model is identified based on a manifest file received from a communication network. As shown in block 930 of FIG. 9A there is, based on determined factors, requesting from the communication network a model update to trigger the model update for use with the currently deployed or stored at least one machine learning model. As shown in block 940 of FIG. 9A there is, based on the request, receiving information from the communication network comprising the model update. Then as shown in block 950 of FIG. 9A there is based on the information, performing a model update to update the currently deployed or stored at least one machine learning model.

In accordance with the example embodiments as described in the paragraph above, wherein performing the model update comprises: based on the information from the communication network, establishing a bit incremental model delivery for a split inference session; and based on the bit incremental model delivery, identifying during each of more than one occasion an inference output result from the artificial intelligence inference engine, wherein based on an inference output result at each occasion of the more than one occasion, the model update comprises a model subset bit precision update of the currently deployed or stored at least one machine learning model.

In accordance with the example embodiments as described in the paragraph above, wherein the currently deployed or stored at least one machine learning model is based on identifying a machine learning model to be downloaded; and requesting an the identified machine learning model from a server of the communication network.

In accordance with the example embodiments as described in the paragraphs above, wherein the model update is received with an artificial intelligence model access function of the apparatus.

In accordance with the example embodiments as described in the paragraphs above, wherein a model run by an inference engine is updated to a higher precision using the model update.

In accordance with the example embodiments as described in the paragraphs above, wherein the model update is performed on the deployed or stored at least one machine learning model without affecting inference operations being executed by the inference engine.

In accordance with the example embodiments as described in the paragraphs above, wherein there is performing a hot swap between the currently deployed at least one machine learning model and an updated model based on the model update.

In accordance with the example embodiments as described in the paragraphs above, wherein the model update is based on one or more of: a model manifest file, information about client resources, network conditions, or machine learning application requirements.

In accordance with the example embodiments as described in the paragraphs above, wherein there is receiving an identified model manifest file from the communication network; and based on at least part of the manifest file, identifying a lower precision version of a model or a model subset to be downloaded for use by the artificial intelligence inference engine.

In accordance with the example embodiments as described in the paragraphs above wherein the lower precision version of a model or a model subset comprises a representation wherein some or all weights are represented using a bit precision representation lower than that of a corresponding higher precision model or model subset.

In accordance with the example embodiments as described in the paragraphs above, wherein the lower precision version of a model or a model subset comprises a representation wherein some or all weights are quantized versions of the corresponding weights in a higher precision model or model subset.

In accordance with the example embodiments as described in the paragraphs above, wherein the lower precision version of a model or a model subset comprises a representation wherein some parts of the computational graph in a higher precision model are pruned, for example, by setting the value a node and its subsequent child nodes to zero.

In accordance with the example embodiments as described in the paragraphs above, wherein the identified model manifest file is based on one or more of: client resources, network conditions; or machine learning application requirements.

In accordance with the example embodiments as described in the paragraphs above, wherein the triggering the model update is at a particular time period, and wherein the particular time period is one of: immediately after receiving the at least one machine learning model, or triggering the model update after a period of time.

In accordance with the example embodiments as described in the paragraphs above, wherein the determined factors comprise at least one of: a model update delivery time, achievable machine learning model accuracy, prospective accuracy improvement achievable with a model update, or a change in accuracy requirements of the client application.

A non-transitory computer-readable medium (MEM 10B as in FIG. 8) storing program code (PROG 10C as in FIG. 8), the program code executed by at least one processor (DP 10A as in FIG. 8) to perform the operations as at least described in the paragraphs above.

In accordance with an example embodiment of the invention as described above there is an apparatus comprising: means for executing (TRANS 10D; MEM 10B, PROG 10C, and DP 10A as in FIG. 8) a machine learning inference loop of a currently deployed or stored (TRANS 10D; MEM 10B, PROG 10C, and DP 10A as in FIG. 8) at least one machine learning model, wherein the currently deployed or stored at least one machine learning model is identified (TRANS 10D; MEM 10B, PROG 10C, and DP 10A as in FIG. 8) based on a manifest file received from a communication network (Network 1 as in FIG. 8); means, based on determined factors, for requesting (TRANS 10D; MEM 10B, PROG 10C, and DP 10A as in FIG. 8) from the communication network (Network 1 as in FIG. 8) a model update to trigger the model update for use with the currently deployed or stored at least one machine learning model; means, based on the request, for receiving (TRANS 10D; MEM 10B, PROG 10C, and DP 10A as in FIG. 8) information from the communication network comprising the model update; and means, based on the information, for performing (TRANS 10D; MEM 10B, PROG 10C, and DP 10A as in FIG. 8) a model update to update the currently deployed or stored at least one machine learning model

In the example aspect of the invention according to the paragraph above, wherein at least the means for executing, deploying or storing, requesting, receiving, and performing comprises non-transitory computer-readable medium (MEM 10B as in FIG. 8) storing program code (PROG 10C as in FIG. 8), the program code executed by at least one processor (DP 10A as in FIG. 8).

FIG. 9B shows a method in accordance with example embodiments of the invention which may be performed by an apparatus.

FIG. 9B illustrates operations which may be performed by a device such as, but not limited to, a device such as a network device (e.g., the NN 12 and/or NN 13 as in FIG. 8). As shown in block 950 of FIG. 9B there is receiving, based on determined factors, from a user equipment a communication to trigger a machine learning model update for use with a currently deployed or stored at least one machine learning model at the user equipment. As shown in block 960 of FIG. 9B there is, based on the communication, determining information comprising the model update. Then as shown in block 970 of FIG. 9B there is, based on the determining, sending towards the client the information comprising the model update for a model update to update the currently deployed or stored at least one machine learning model

In accordance with the example embodiments as described in the paragraph above, wherein sending the model update comprises: based on the information, establishing a bit incremental model delivery for a split inference session; and based on the bit incremental model delivery, identifying during each of more than one occasion an inference output result from the artificial intelligence inference engine, wherein based on an inference output result at each occasion of the more than one occasion, the model update comprises a model subset bit precision update of the currently deployed or stored at least one machine learning model.

In accordance with the example embodiments as described in the paragraphs above, wherein the currently deployed or stored at least one machine learning model is based on receiving from the user equipment a request an the identified machine learning model to be downloaded by the user equipment.

In accordance with the example embodiments as described in the paragraphs above, wherein the currently deployed or stored at least one machine learning model is based on receiving from the user equipment a request for an identified machine learning model.

In accordance with the example embodiments as described in the paragraphs above, wherein the machine learning model update is sent with a network application.

In accordance with the example embodiments as described in the paragraphs above, wherein the machine learning model update is for updating the at least one of the currently deployed or stored at least one machine learning model to a higher precision model.

In accordance with the example embodiments as described in the paragraphs above, wherein the machine learning model update is for use on the stored at least one machine learning model without affecting inference operations being executed by the client.

In accordance with the example embodiments as described in the paragraphs above, wherein the precision update comprises a hot swap between the currently deployed at least one machine learning model and an updated model based on the precision update.

In accordance with the example embodiments as described in the paragraphs above, wherein the model update is based on one or more of: a model manifest file, information about client resources, network conditions, or machine learning application requirements.

In accordance with the example embodiments as described in the paragraphs above, wherein there is sending an identified model manifest file from the communication network, wherein based on at least part of the manifest file, a lower precision version of a model or a model subset can be identified to be downloaded for use by the client.

In accordance with the example embodiments as described in the paragraphs above, wherein the lower precision version of a model or a model subset comprises a representation wherein some or all weights are represented using a bit precision representation lower than that of a corresponding higher precision model or model subset.

In accordance with the example embodiments as described in the paragraphs above, wherein the lower precision version of a model or a model subset comprises a representation wherein some or all weights are quantized versions of the corresponding weights in a higher precision model or model subset.

In accordance with the example embodiments as described in the paragraphs above, wherein the lower precision version of a model or a model subset comprises a representation wherein some parts of the computational graph in a higher precision model are pruned, for example, by setting the value a node and its subsequent child nodes to zero.

In accordance with the example embodiments as described in the paragraphs above, wherein the identified model manifest file is based on one or more of: client resources, network conditions; or machine learning application requirements.

In accordance with the example embodiments as described in the paragraphs above, wherein the triggering the model update is at a particular time period, and wherein the particular time period is one of: immediately after receiving the at least one machine learning model, or triggering the model update after a period of time

In accordance with the example embodiments as described in the paragraphs above, wherein the determined factors comprise at least one of: a model update delivery time, achievable machine learning model accuracy, prospective accuracy improvement achievable with a model update, or a change in accuracy requirements of the client application.

A non-transitory computer-readable medium (MEM 12B and/or MEM 13B as in FIG. 8) storing program code (PROG 12C and/or PROG 13C as in FIG. 8), the program code executed by at least one processor (DP 12A and/or DP 13A as in FIG. 8) to perform the operations as at least described in the paragraphs above.

In accordance with an example embodiment of the invention as described above there is an apparatus comprising: means for receiving (TRANS 12D and/or TRANS 13D; MEM 12B and/or MEM 13B, PROG 12C and/or PROG 13C, and DP 12A and/or DP 13A as in FIG. 8), based on determined (TRANS 12D and/or TRANS 13D; MEM 12B and/or MEM 13B, PROG 12C and/or PROG 13C, and DP 12A and/or DP 13A as in FIG. 8) factors, from a user equipment (UE 10 as in FIG. 8) a communication to trigger a machine learning model update for use with a currently deployed or stored at least one machine learning model at the user equipment; based on the communication, determining (TRANS 12D and/or TRANS 13D; MEM 12B and/or MEM 13B, PROG 12C and/or PROG 13C, and DP 12A and/or DP 13A as in FIG. 8) information comprising the model update; and based on the determining, sending (TRANS 12D and/or TRANS 13D; MEM 12B and/or MEM 13B, PROG 12C and/or PROG 13C, and DP 12A and/or DP 13A as in FIG. 8) towards the client the information comprising the model update for a model update to update the currently deployed or stored at least one machine learning model.

In the example aspect of the invention according to the paragraph above, wherein at least the means for receiving, determining, and sending comprises non-transitory computer-readable medium (MEM 10B as in FIG. 8) storing program code (PROG 10C as in FIG. 8), the program code executed by at least one processor (DP 10A as in FIG. 8).

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations in accordance with example embodiments of the invention as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of example embodiments of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1. An apparatus, comprising:
at least one processor; and
at least one memory storing instructions, that when executed by the at least one processor, cause the apparatus at least to:
execute a machine learning inference loop of a currently deployed or stored at least one machine learning model,
wherein the currently deployed or stored at least one machine learning model is identified based on a manifest file received from a communication network;
based on determined factors, request from the communication network a model update to trigger the model update for use with the currently deployed or stored at least one machine learning model;
based on the request, receive information from the communication network comprising the model update; and
based on the information, communicate a trigger for a model update to update the currently deployed or stored at least one machine learning model.

2. The apparatus of claim 1, wherein
based on the trigger, perform a model update comprising: the at least one memory is storing instructions is executed by the at least one processor, to cause the apparatus to:
based on the information from the communication network, establish a bit incremental model delivery for a split inference session; and
based on the bit incremental model delivery, identify during each of more than one occasion an inference output result from the artificial intelligence inference engine,
wherein based on an inference output result at each occasion of more than one occasion, the model update comprises a model subset bit precision update of the currently deployed or stored at least one machine learning model.

3. The apparatus of claim 1, wherein the currently deployed or stored at least one machine learning model is based on the at least one memory storing instructions, executed by the at least one processor, to cause the apparatus to:
identify a machine learning model to be downloaded; and
request an identified machine learning model from a server of the communication network.

4. The apparatus of claim 1, wherein the model update is received with an artificial intelligence model access function of the apparatus.

5. The apparatus of claim 2, wherein a model run by an inference engine is updated to a higher precision using the model update.

6. The apparatus of claim 5, wherein the model update is performed on the deployed or stored at least one machine learning model without affecting inference operations being executed by the inference engine.

7. The apparatus of claim 1, wherein the at least one memory storing instructions, is executed by the at least one processor, to cause the apparatus to:
perform a hot swap between the currently deployed at least one machine learning model and an updated model based on the model update.

8. The apparatus of claim 1, wherein the model update is based on one or more of:
a model manifest file, information about client resources, network conditions, or machine learning application requirements.

9. The apparatus of claim 1, wherein the at least one memory storing instructions, is executed by the at least one processor, to cause the apparatus to:
receive an identified model manifest file from the communication network; and
based on at least part of the manifest file, identify a lower precision version of a model or a model subset to be downloaded for use by the artificial intelligence inference engine.

10. The apparatus of claim 9, wherein the lower precision version of a model or a model subset comprises a representation wherein some or all weights are represented using a bit precision representation lower than that of a corresponding higher precision model or model subset.

11. The apparatus of claim 9, wherein the lower precision version of a model or a model subset comprises a representation wherein some or all weights are quantized versions of the corresponding weights in a higher precision model or model subset.

12. The apparatus of claim 9, wherein the lower precision version of a model or a model subset comprises a representation wherein some parts of the computational graph in a higher precision model are pruned, for example, by setting the value a node and its subsequent child nodes to zero.

13. The apparatus of claim 9, wherein the identified model manifest file is based on one or more of: client resources, network conditions; or machine learning application requirements.

14. The apparatus of claim 1, wherein the triggering the model update is at a particular time period, and wherein the particular time period is one of:
immediately after receiving the at least one machine learning model, or
triggering the model update after a period of time.

15. The apparatus of claim 1, wherein the determined factors comprise at least one of:
a model update delivery time, achievable machine learning model accuracy, prospective accuracy improvement achievable with a model update, or a change in accuracy requirements of the client application.

16. A method, comprising:
executing a machine learning inference loop of a currently deployed or stored at least one machine learning model,
wherein the currently deployed or stored at least one machine learning model is identified based on a manifest file received from a communication network;
based on determined factors, requesting from the communication network a model update to trigger the model update for use with the currently deployed or stored at least one machine learning model;
based on the request, receiving information from the communication network comprising the model update; and
based on the information, communicate a trigger for a model update to update the currently deployed or stored at least one machine learning model.

17. An apparatus, comprising:
at least one processor; and
at least one memory storing instructions, that when executed by the at least one processor, cause the apparatus at least to:
receive, based on determined factors, from a user equipment a communication to trigger a machine learning model update for use with a currently deployed or stored at least one machine learning model at the user equipment;
based on the communication, determine information comprising the model update;
based on the determining, send towards the client the information comprising the model update for a model update to update the currently deployed or stored at least one machine learning model.

18. The apparatus of claim 17, wherein sending the trigger for the model update comprises: the at least one memory storing instructions executed by the at least one processor, to cause the apparatus to:
based on the information, establish a bit incremental model delivery for a split inference session; and
based on the bit incremental model delivery, identify during each of more than one occasion an inference output result from the artificial intelligence inference engine,
wherein based on an inference output result at each occasion of the more than one occasion, the model update comprises a model subset bit precision update of the currently deployed or stored at least one machine learning model.

19. The apparatus of claim 17, wherein the currently deployed or stored at least one machine learning model is based on the at least one memory storing instructions, executed by the at least one processor, to cause the apparatus to:
receive from the user equipment a request an the identified machine learning model to be downloaded by the user equipment.

20. The apparatus of claim 17, wherein the currently deployed or stored at least one machine learning model is based on the at least one memory storing instructions, executed by the at least one processor, to cause the apparatus to:
receive from the user equipment a request for an identified machine learning model.

21. The apparatus of claim 17, wherein the machine learning model precision update is sent with a network application.

22. The apparatus of claim 17, wherein the machine learning model precision update is for updating the at least one of the currently deployed or stored at least one machine learning model to a higher precision model.

23. The apparatus of claim 17, wherein the machine learning model precision update is for use on the stored at least one machine learning model without affecting inference operations being executed by the client.

24. The apparatus of claim 17, wherein the precision update comprises a hot swap between the currently deployed at least one machine learning model and an updated model based on the precision update.

25. The apparatus of claim 17, wherein the model update is based on one or more of:
a model manifest file, information about client resources, network conditions, or machine learning application requirements.

26. The apparatus of claim 17, wherein the at least one memory storing instructions, is executed by the at least one processor, to cause the apparatus to:
send an identified model manifest file from the communication network, wherein based on at least part of the manifest file, a lower precision version of a model or a model subset can be identified to be downloaded for use by the client.

27. The apparatus of claim 26, wherein the lower precision version of a model or a model subset comprises a representation wherein some or all weights are represented using a bit precision representation lower than that of a corresponding higher precision model or model subset.

28. The apparatus of claim 26, wherein the lower precision version of a model or a model subset comprises a representation wherein some or all weights are quantized versions of the corresponding weights in a higher precision model or model subset.

29. The apparatus of claim 26, wherein the lower precision version of a model or a model subset comprises a representation wherein some parts of the computational graph in a higher precision model are pruned, for example, by setting the value a node and its subsequent child nodes to zero.

30. The apparatus of claim 26, wherein the identified model manifest file is based on one or more of: client resources, network conditions; or
machine learning application requirements.

31. The apparatus of claim 17, wherein the triggering the model update is at a particular time period, and wherein the particular time period is one of:
immediately after receiving the at least one machine learning model, or
triggering the model update after a period of time

32. The apparatus of claim 17, wherein the determined factors comprise at least one of:
a model update delivery time,
achievable machine learning model accuracy,
prospective accuracy improvement achievable with a model update, or a change in accuracy requirements of the client application.

33. A method, comprising:
receiving, based on determined factors, from a user equipment a communication to trigger a machine learning model update for use with a currently deployed or stored at least one machine learning model at the user equipment;
based on the communication, determining information comprising the model update;
based on the determining, sending towards the client the information comprising the model update for a model update to update the currently deployed or stored at least one machine learning model.
